(19) United States
(12) Patent Application Publication
(10) Pub. No.: US 2014/0274119 A1
(43) Pub. Date: Sep. 18, 2014

(54) METHOD AND APPARATUS FOR INDOOR POSITIONING BASED ON WIRELESS LANDMARKS

(71) Applicant: QUALCOMM INCORPORATED, San Diego, CA (US)

(72) Inventors: Sai Pradeep Venkatraman, Santa Clara, CA (US); Weihua Gao, San Jose, CA (US); Vinay Sridhara, Santa Clara, CA (US)

(73) Assignee: QUALCOMM Incorporated, San Diego, CA (US)

(21) Appl. No.: 13/839,997

(22) Filed: Mar. 15, 2013

(51) Int. Cl. H04W 4/02

(52) U.S. Cl. CPC H04W 4/02
USPC 455/456.1

(57) ABSTRACT

Embodiments include using a wireless access point (AP) as a landmark to aid precise wireless indoor positioning of a mobile device. The AP transmits a wireless indoor positioning signal with a predetermined or known frequency and power that is typically only able to be detected and decoded by any of various types of mobile devices that are within a predetermined “close” range of the AP. Based on positioning the mobile device within the predetermined range, the device may calibrate one or more physical sensors of the mobile device for indoor positioning. Such wireless landmarks provide more accurate, efficient, automated and reliable wireless indoor positioning and sensor calibration.

### BACKGROUND

I. Field of the Invention

The subject matter disclosed herein relates to indoor positioning of mobile electronic devices based on signals from wireless access points.

II. Background

Global navigation satellite systems (GNSS), such as a global positioning satellite (GPS) system, are not suitable for indoor positioning because microwaves transmitted by the satellites are attenuated and scattered by roofs, walls, and other objects in the building. Therefore a method of indoor positioning based on Wi-Fi signals transmitted by wireless access points was developed. In some cases, to provide the service, a grid and a corresponding Wi-Fi signal heatmap are established for an indoor venue (identified by a LCI, or Location Context Identifier). For each grid point, the heatmap includes statistical information about Wi-Fi signals transmitted by a plurality of wireless access points (AP). Usually the statistical information used includes the mean and the standard deviation of RSSI (Received Signal Strength Indication) values and/or RTT (Round-Trip Time) values for signals transmitted from a plurality of access points. The heatmap is provided to end-users of the indoor positioning system as AD (Assistance Data).

In some cases, to provide the service, a mobile device will use sensors, such as physical sensors to determine its indoor position (e.g., location). Such sensors may include accelerometers, gyros, and the like. Such sensors may be used in cooperation with, or independently of a heat map, to determine indoor position of a mobile device. Such sensors may also assist in determining outdoor position.

Therefore an indoor positioning system that provides for more accurate positioning or sensor calibration is useful.

### BRIEF SUMMARY

Embodiments of this invention include methods, devices, systems and means for using wireless access point (AP) as landmarks to aid precise wireless indoor positioning. Embodiments provide adaptive indoor positioning using a wireless indoor positioning signal transmitted from a wireless access point (AP) to a mobile device to determine the position of the device. In some cases, the wireless indoor positioning signal may be a coded response from the AP to a general unicast request from the mobile device. In some cases, the request may be a specific request for the positioning signal. In some cases, the AP may send out the positioning signal without receiving a unicast request, such as when the AP sends out a periodic positioning signal. In some embodiments, such positioning may include calibrating one or more physical sensors of the mobile device for indoor positioning.

The mobile device may include a receiver to receive and detect a signal from a wireless signal transmitter or wireless access point (AP). The signal is transmitted with a predetermined or known frequency and power that is typically only able to be detected and decoded by any of various types of mobile devices that are within a predetermined range of the AP. By providing wireless landmarks, embodiments describe herein provide more accurate, efficient and reliable wireless indoor positioning and sensor calibration.

Some embodiments are directed to a machine implemented method to perform wireless indoor positioning of a mobile device. This method may include generating a signal to transmit to the mobile device, the signal to be received and decoded at the mobile device; wherein the signal has a predetermined transmission rate and a predetermined power that is known to be decodable by a plurality of typical types of mobile devices only when the mobile devices are within a predetermined distance from the transmitter; wherein the signal includes data identifying a location of the AP, that the signal has the predetermined transmission rate, and that the signal has the predetermined power; and transmitting the signal to the mobile device.

Some embodiments are directed to a machine implemented method to calibrate sensors of a mobile device for indoor positioning. This method may include transmitting a general unicast request signal; receiving a wireless signal from a transmitter, in response to the general unicast request signal; decoding the received signal into a decoded signal; based on data of the decoded signal, determining that the received wireless signal has a predetermined power and predetermined frequency; based on determining, identifying a position of the mobile device; and based on the position, calibrating a physical sensor of the mobile device within thresholds used for indoor positioning.

Some embodiments are directed to a device to perform wireless indoor positioning of a mobile device. This device may include an indoor positioning signal generator configured to generate a signal to transmit to a mobile device, the signal to be received and decoded at the mobile device; wherein the signal has a predetermined transmission rate and a predetermined power that is known to be decodable by a plurality of typical types of mobile devices only when the mobile devices are within a predetermined distance from the transmitter; wherein the signal includes data identifying a location of the AP, that the signal has the predetermined transmission rate, and that the signal has the predetermined power; and a wireless signal transmitter configured to transmit the signal to the mobile device.

Some embodiments are directed to a device to perform calibration of sensors of a mobile device for indoor positioning. This device may include a wireless signal transmitter configured to transmit a general unicast request signal; a wireless signal receiver configured to receive a wireless signal from an AP transmitter, in response to the general unicast request signal; a decoder configured to decode the received signal into a decoded signal; and a positioning processor configured to, based on data of the decoded signal, determine that the received wireless signal has a predetermined power and predetermined frequency; based on determining, identify a position of the mobile device; and based on the position, calibrate a physical sensor of the mobile device within thresholds used for indoor positioning.

Some embodiments are directed to a computer program product comprising a non-transitory computer-readable medium to perform wireless indoor positioning of a mobile device. The product comprising code for generating a signal to transmit to a mobile device, the signal to be received and decoded at the mobile device; wherein the signal has a predetermined transmission rate and a predetermined power that is known to be decodable by a plurality of typical types of mobile devices only when the mobile devices are within a predetermined distance from the transmitter; wherein the signal includes data identifying a location of the AP, that the signal has the predetermined transmission rate, and that the signal has the predetermined power; and transmitting the signal to the mobile device.

Some embodiments are directed to a computer program product comprising a non-transitory computer-readable medium to perform calibration of sensors of a mobile device for indoor positioning. The product comprising code for transmitting a general unicast request signal; receiving a wireless signal from a transmitter, in response to the general unicast request signal; decoding the received signal into a decoded signal; based on data of the decoded signal, determining that the received wireless signal has a predetermined power and predetermined frequency; based on determining, identifying a position of the mobile device; and based on the position, calibrating a physical sensor of the mobile device within thresholds used for indoor positioning.

Some embodiments are directed to a computing device to perform wireless indoor positioning of a mobile device. The device including a means for generating a signal to transmit to a mobile device, the signal to be received and decoded at the mobile device; wherein the signal has a predetermined transmission rate and a predetermined power that is known to be decodable by a plurality of typical types of mobile devices only when the mobile devices are within a predetermined distance from the transmitter; wherein the signal includes data identifying a location of the AP, that the signal has the predetermined transmission rate, and that the signal has the predetermined power; and a means for transmitting the signal to the mobile device.

Some embodiments are directed to a computing device to perform calibration of sensors of a mobile device for indoor positioning. The device including a means for transmitting a general unicast request signal; a means for receiving a wireless signal from a transmitter, in response to the general unicast request signal; a means for decoding the received signal into a decoded signal; a means for, based on data of the decoded signal, determining that the received wireless signal has a predetermined power and predetermined frequency; a means for, based on determining, identifying a position of the mobile device; and a means for, based on the position, calibrating a physical sensor of the mobile device within thresholds used for indoor positioning.

The above summary does not include an exhaustive list of all aspects of the various embodiments. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWING

The features, nature, and advantages of the present disclosure will become more apparent from the detailed description set forth below when taken in conjunction with the drawings in which like reference characters identify correspondingly throughout.

FIG. 1A shows an example of a flow diagram of process 100 for performing adaptive indoor positioning using a wireless indoor positioning signal transmitted from an AP.

FIG. 1B shows an example of a flow diagram of process 101 for performing adaptive indoor positioning using a wireless indoor positioning signal transmitted from an AP.

FIG. 1C shows an example of a flow diagram of process 102 for performing adaptive indoor positioning using a wireless indoor positioning signal transmitted from an AP.

FIG. 2 shows an example of an adaptive indoor positioning system that uses a wireless indoor positioning signal transmitted from an AP.

FIG. 3 shows example process for determining that a received wireless signal has a predetermined power and predetermined frequency, based on data of the decoded signal.

FIG. 4 shows an example of a block diagram of a system or device in which aspects of embodiments of the invention may be practiced.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the disclosure.

Position determination techniques described herein may be implemented in conjunction with various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

A satellite positioning system (SPS) typically includes a system of transmitters positioned to enable entities to determine their location on or above the Earth based, at least in part, on signals received from the transmitters. Such a transmitter typically transmits a signal marked with a repeating pseudo-random noise (PN) code of a set number of chips and may be located on ground based control stations, user equipment and/or space vehicles. In a particular example, such transmitters may be located on Earth orbiting satellite vehicles (SVs). For example, a SV in a constellation of Global Navigation Satellite System (GNSS) such as Global Positioning System (GPS), Galileo, GLONASS or Compass may transmit a signal marked with a PN code that is distinguishable from PN codes transmitted by other SVs in the constellation (e.g., using different PN codes for each satellite as in GPS or using the same code on different frequencies as in GLONASS). In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

As used herein, a mobile device, sometimes referred to as a mobile station (MS) or user equipment (UE), such as a cellular phone, mobile phone or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals. The term “mobile device” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile device” is intended to include all devices, including wireless communication devices, computers, laptops, etc. which are capable of communication with a server, such as via the Internet, WiFi, or other network, and regardless of whether satellite signal reception, assistance data reception, and/or position-related processing occurs at the device, at a server, or at another device associated with the network. Any operable combination of the above are also considered a “mobile device.”

Embodiments of this invention include methods, devices, systems and means for providing wireless landmarks to aid precise wireless indoor positioning. Embodiments describe an indoor positioning system that provides for more accurate sensors and/or sensor calibration. The technology applies to wireless indoor and/or outdoor positioning of a mobile device. Such positioning may include determining, identifying or detecting the location with respect to a wireless an access point (AP) or a reference frame, such as longitude and latitude, or a reference frame within a land plot, land lot, city block, building, etc. In some embodiments, such positioning may include calibrating one or more physical sensors of the mobile device for indoor positioning.

Embodiments may apply to or provide indoor positioning of typical types of mobile devices such as various makes, models and/or types of mobile device of mobile phones, pad computers, laptop computers, and the like. The device may be a mobile hand held device having a receiver to detect a signal from a wireless access point (AP). The access point may be a local, terrestrial, Wi-Fi, or other radio transmitter of data. This may be opposed to global positioning systems that use signals from satellites. In some cases, determining the indoor position of the mobile device, excludes or is done independently of any GPS type signal received by the mobile device.

In embodiments, an adaptive indoor positioning system may use a wireless indoor positioning signal transmitted from an AP to a mobile device to determine the position of the device. In some cases, the wireless indoor positioning signal may be a coded response from the AP to a general unicast request from the mobile device. The request may be a general unicast request signal as known in the art. In some cases, the request may be a specific request for the positioning signal. In some cases, the AP may send out the positioning signal without receiving a unicast request, such as when the AP sends out a positioning signal periodically, or otherwise (e.g., as noted further below for blocks 110-112 and 132-134).

The device may include a receiver configured to receive and detect a signal from a wireless signal transmitter or wireless access point (AP). The signal may be transmitted with (e.g., has) a predetermined or known frequency and power that is typically only able to be detected and decoded by any of various types of mobile devices that are within a predetermined range of the AP (e.g., with some uncertainty, as noted further below for blocks 114 and 142).

FIG. 1 shows an example of a flow diagram of process 100 for performing adaptive indoor positioning using a wireless indoor positioning signal transmitted from an AP. FIG. 2 shows an example of an adaptive indoor positioning system 200 that uses a wireless indoor positioning signal transmitted from an AP. FIG. 2 shows APs 1-3; mobile device 400; device signal 210; wireless indoor positioning signal 220; and time delays Tf, TdAP and Tms. System 200 (e.g., AP1 and device 400) may be used to implement the process described in FIGS. 1-3.

FIG. 1 shows process 100 having optional block 110 where mobile device 400 generates and transmits device signal 210 to wireless access point AP1. Signal 210 takes time Tms to generate and transmit, and time Tf to reach AP1. Signal 210 may be a general unicast request signal, such as known in the art. Signal 210 may include a request for or that mobile device positioning (e.g., RTT) is to be determined. In some cases, the unicast request is from a mobile request, and in other some cases it is from a non-mobile or stationary device. In some cases, block 110 is not performed.

At block 112, AP1 generates and transmits (indoor positioning) signal 220 to mobile device 400, (1) in response to receiving (e.g., and decoding) signal 210 or (2) as a periodic signal or otherwise. Block 112 may include creating and/or transmitting the wireless indoor positioning signal having a predetermined power and frequency (e.g., to a mobile device) as noted herein. Signal 220 takes time TdAP to generate and transmit, and time Tf to reach mobile device 400.

Signal 220 may have a predetermined (e.g., predicted by device 400) transmission rate and a predetermined power that is known to be decodable by a plurality of typical types of mobile devices only when the mobile devices are within a predetermined distance (e.g., “range”) from the transmitter. The predetermined transmission rate and/or predetermined power may be previously determined by experimentation, such as during design or development of the AP and/or device 400. They may also be previously determined by hysteresis during use of device 400 or AP1. They may be updated, such as by updating programming of device 400 and/or AP as known in the art.

In some cases, this predetermined distance may include or account for some added uncertainty owing to (e.g., due to or as a result of) signal fading and other random signal fluctuations. Signal 220 may include data identifying a position of the AP, that the signal has the predetermined transmission rate, and that the signal has the predetermined power.

In some cases, the AP may send out (e.g., transmit) the positioning signal without receiving a unicast request (e.g., block 110), such as when the AP sends out a positioning signal periodically or otherwise. It is noted that an AP may send out beacons periodically and not initiated by mobile devices. In some cases, the Request-Response of blocks 110-112 is needed if a mobile device position (e.g., RTT) is to be determined. In some cases, the request can be originated by either the mobile station (for the Mobile Based Positioning) or the Access Point (for the Network Based Positioning).

In some cases, the AP (e.g., AP1) may be a physically fixed or may be a removable device, as known in the art. In some cases the AP is a device that is mounted or fixed at a location, such as by being mounted on a wall, ceiling or piece of furniture. In some cases an AP has the functions known in the art for an AP; and also has the functions or abilities noted herein. In some embodiments, signals 210 and 220 may be wireless transmissions or signals, such as noted below for receiver 414 and transmitter 440 of FIG. 4 (e.g., such as including Wi-Fi signals and data). AP1 may communicate with device 400 (and vice versa) using various wireless technologies, such as noted below for receiver 414 and transmitter 440 of FIG. 4. AP1 may also include other components and logic as noted below after FIG. 4.

At block 114, device 400 receives and decodes signal 220. Decoding may include decoding the received signal into a decoded signal. Block 114 may include device 400 receiving a wireless signal from a transmitter, in response to the general unicast request signal.

At decision block 116 it is determined whether signal 220 is decodable by device 400. In some cases, if the signal is not decodable, process 100 returns to block 110 (or block 112 if block 110 is not performed). In this case, it may be determined by device 400 that it is farther from AP1, or from any AP than a very close range at which various types of mobile devices are able to decode a received signal having a predetermined power and frequency known only to be detected at the close range. If the signal is decodable, process 100 continues to block 118.

At block 118, based on data of the decoded signal, device 400 determines or identifies that the received wireless signal has a predetermined power and predetermined frequency. In some cases, block 118 includes that based on predetermined data of the decoded signal, device 400 identifies the received wireless signal as a predetermined a wireless indoor positioning beacon. In some cases, block 118 includes that based on predetermined data of the decoded signal, device 400 identifies the predetermined power and the predetermined frequency of the signal.

Block 118 may include determining that decoded data of the wireless signal (e.g., such as in a signal header, signal identification, signal type or signal name data) identifies the signal as being an indoor positioning signal or as having a predetermined power and predetermined frequency. In some cases, the decoded data identifies that the signal that is (1) a coded indoor positioning response from the AP to a general unicast request from the mobile device, or (2) a periodic indoor positioning signal. In some cases it may be both (1) and (2).

FIG. 3 shows example process 300 for determining that a received wireless signal has a predetermined power and predetermined frequency, based on data of the decoded signal. FIG. 3 shows process 300 which may be a process for performing block 118.

At block 310 data of the decoded signal is received. Block 310 may include device 400 receiving data of decoding signal 220 (e.g., such as from data decoded at block 114).

At decision block 320 it is determined whether the decoded data includes predetermined data identifying the received wireless signal as a predetermined wireless indoor positioning beacon that is a response from the AP (e.g., AP1) to a general unicast request from the mobile device, or a periodic indoor positioning signal. If the data does, processing continues to block 120. If the data does not, processing returns to block 110 (or block 112 if block 110 is not performed).

At decision block 330 it is determined whether the decoded data includes predetermined data identifying the received wireless signal as having a predetermined power and a predetermined frequency of the signal. If the data does, processing continues to block 120. If the data does not, processing returns to block 110 (or block 112 if block 110 is not performed).

At block 120, based on that determination, device 400 identifies a position of the device 400 (e.g., relative the location of the AP and/or relative to a coordinate system). In some cases block 120 includes, based on predetermined data of the decoded signal, identifying a location of the AP, and based on the location of the AP, determining a location of the mobile device relative to the transmitter.

At block 122 (optional), based on the position, device 400 calibrates at least one physical sensor of device 400. Block 122 may include calibrating the sensor(s) sufficiently for the sensors to perform or assist in performing indoor positioning. In some cases, the identified position is close enough to the AP so that sensors can be calibrated with error thresholds low enough so that the sensors can be successfully used to perform indoor positioning within a predetermined degree of tolerance. For example, a positioning range uncertainty of 1 m could lead to a of delay timing delay from the AP and mobile device, or turnaround calibration factor (TCF) uncertainty of 3 ns, as noted below. In some cases, block 122 is not performed.

The wireless indoor positioning signal may be transmitted with (e.g., has) a predetermined or known data that once decoded, identifies the type of signal (or that the signal has the predetermined frequency and power). Thus, the positioning logic (software and/or hardware) of the device can calibrate its sensors because the device receives from the AP, the known location of the AP. Thus, the device knows is at or close enough to that location to use that location as the devices location when calibrating the sensors. In some cases, by knowing that the mobile device is within a certain range of the AP, the mobile device knows its location (e.g., at the location of the AP, which identified the AP location in the message to the mobile device) and thus can calibrate sensors for indoor positioning, such as accelerometers, gyros, and the like. It can also update its location position based on being at the known location. Either of these can be described as “correcting sensor drift.”

In some cases, the device can also use the location and signal detection to update a heat map data. For instance, a heat map may be updated based on or using the location of device 400 and the strength and frequency of the received and decoded signal. For example, RSSI heatmaps that are provided to the mobile device (e.g., device 400) as part of the assistance data that device receives for positioning, may be generated with assumed AP transmit powers (e.g., from APs). In some cases, when a mobile device's position is known (e.g., based on block 120), a comparison can be made (e.g., by the mobile phone or another computer that generates the heatmap) between the predicted/assumed RSSI for heatmaps at that location and the observed actual RSSI values detected by device 400, and the offset between the two may be determined. These offsets may be subtracted or added to the heatmaps to generate a more accurate heatmap representative of the current transmit power levels. For instance, in some cases, the difference or offset between the assumed RSSI and the observed actual RSSI at a location may be used to update that location's assumed RSSI, as well as to update the heatmap's assumed RSSI for related or adjacent locations, based on the offsets. In some cases a heatmap contain the predicted RSSI at each node or location, where the RSSI at a node is the AP transmit power minus the attenuation due to signal propagation.

If the distance between the AP and device is greater than the close distance or very close distance (e.g., greater than 3 or 4 meters), signal processing of the device may or will fail to decode the signal.

In some embodiments, the AP transmits, and the device receives, and decodes, a known data beacon that is known to be transmitted at a predetermined power and a predetermined frequency. The data in the frame includes data identifying the beacon as the known beacon. The predetermined power may be less than a power that is known to be detectable by various mobile devices at a known close distance or range. The decoded signal includes information identifying it as a known data beacon/frame. Decoding the signal successfully allows the mobile device to know it is with a certain distance of the AP.

In some embodiments, the transmitted and received wireless indoor positioning signal is at a predetermined power and frequency known only to be detected at a very close range by mobile devices. The signal may only be detectable and decodable if it is received within a predetermined limited distance range from the AP or the AP's signal transmitter. In this case, the signal may identify the frequency and power of the signal, but not that it is a positioning beacon.

In general, the difference in time between when a signal (e.g., a general unicast request signal, or a signal requesting a return signal) is sent by a mobile device, and when the return signal is received (e.g., a wireless indoor positioning signal from an AP, in response to the general unicast request signal), is Treceived−Tsend=2×Tf+TCF. Here Treceived is the time when the signal is received by the mobile device; Tsend is the time the mobile device sent the request signal; Tf is the time it takes that signal to travel from the AP to the mobile device (and vice versa); and TCF (turnaround calibration factor) may be the response time that it takes the AP (e.g., TdAP) and the mobile device (e.g., Tms) to received, decode, prepare, and send the two signals. TCF may be estimated when Treceive−Tsend is approximately zero (e.g., less than 10 nanoseconds), such as noted below. In some cases, while IEEE standard 802.11 defines SIFS (short inter-frame space) to denote the time the AP takes to respond to a request (e.g., from mobile device 400), TCF may include the delays on of the SIFS on the AP side and other delays on the mobile and AP sides.

In some cases, TdAP, is the response time that it takes the AP to received, decode, prepare, and send a signal, is equal to the Short inter-frame space (SIFS—see standard below) plus an unknown time that is related to the number of bits that need to be modulated to send the signal from the AP. In some cases, Tms, the response time that it takes the mobile device to received, decode, prepare, and send a signal is unknown, such as at least because the make, model and type of mobile device is not known.

In some embodiments, the predetermined frequency and power may be selected so that the “close distance” or “close range” has a maximum of between 2 and 3 meters in distance or range, at which a mobile device can decode a signal from the AP. In some cases, the close distance may be between 0 and 3 meters, such as 2 or 3 meter radius from the AP. The speed of the signal is 3 meters per 10 nanoseconds. For example, a positioning range uncertainty of 1 m could lead to a TCF uncertainty of 3 ns (and vice versa). Thus, in some cases, TCF can be estimated (e.g., calculated based on knowing or estimating TdAP and Tms, such as based on or according to standards) since the transmit time of the signals traveling between the device and AP is approximately 0. This may be done using RSSI logic. Here, TCF is equal to Treceived−Tsent; or equal to the delay of transmission by the AP (TdAP) and the mobile device (Tms). In some cases, here, TCF (the sum of delays on the transmitter and mobile side) is estimated with an uncertainty metric due not knowing the exact delay of the AP or mobile device, but estimating them by setting them to values (1) equal to an average determined by experimentation, or (2) less than or equal to maximum delays according to standards.

Short inter-frame space (SIPS), the time an AP must respond to a mobile device signal within, may be a known or estimated delay of approximately 16500 nanoseconds on average. It may be tied to a standard (IEEE 802.11g) that requires a response within 16 micro seconds+/−900 nano-seconds.

It can be appreciated that for signals 210 and 220, receiver signal strength indicator (RSSI) is a function of transmit power and distance. In some cases, the transmit power can be controlled by looking at the heatmap that is generated by considering the environment and at some default transmit power. As an example, for a pair of transmitter and receiver communicating at with a transmit power of 17 dBm the RSSI at the receiver could be −65 dBm at a Euclidean distance of 10 m (e.g., between the transmitter and receiver) while for a different pair of transmitter and receiver (e.g., different makes or models) the RSSI could be −72 dBm for the same 17 dBm transmit power and a Euclidean distance of 10 m. In some cases the maximum distance at which a signal can be decoded can be 30 m while it could be only 15 m in other scenarios. It should be appreciated that the transmit power and the operating environment plays a critical role in the signal propagation (i.e. both RSSI and the distance at which the signal can be reliably decoded).

It can be appreciated that the concepts above, where Tf is approximately zero, also apply to situations where signal 220 is sent by AP1, periodically or otherwise, as noted above (e.g., and not in response to signal 210, such as where optional block 110 is not performed). In these case, device 400 knows or calculates that it is located a close distance from AP1 based on blocks 112-120.

According to some embodiments, only block 112 (and optionally block 110) is performed. According to some embodiments, only blocks 112-120 (and optionally blocks 110 and 122) are performed. According to some embodiments, only blocks 112-118 (and optionally block 110 or 122) are performed. According to some embodiments, only blocks 112-120 are performed. According to some embodiments, only blocks 110 and 112-120 are performed.

FIG. 1B shows an example of a flow diagram of process 101 for performing adaptive indoor positioning using a wireless indoor positioning signal transmitted from an AP. In some cases, block 132 of FIG. 1B includes generating a signal (e.g., at an AP) to transmit to the mobile device, the signal to be received and decoded at the mobile device; wherein the signal has a predetermined transmission rate and a predetermined power that is known to be decodable by the mobile device only when the mobile device is within a predetermined distance from the transmitter; and wherein the signal includes data identifying a location of an access point (AP). In this case, block 132 may optionally include that the mobile device any one of a plurality of typical types of mobile devices; and/or that the signal includes data identifying that the signal has the predetermined transmission rate, and that the signal has the predetermined power. In this case, block 132 may also optionally include that the signal comprises at least one of (1) a coded response from the AP to a general unicast request from the mobile device, (2) a periodic signal, (3) predetermined data identifying the received wireless signal as a predetermined wireless indoor positioning beacon, and (4) predetermined data identifying the predetermined power and the predetermined frequency of the signal. In some cases, block 132 of FIG. 1B may include descriptions of generating a signal as described in FIG. 1A for block 112. After block 132, process 101 continues to block 134 where the signal (e.g., signal 220) is transmitted (e.g., by AP1) to the mobile device (e.g., device 400). In some cases, block 134 of FIG. 1B may include descriptions of transmitting a signal as described in FIG. 1A for block 112. After block 134, process 101 may return to block 132.

FIG. 1C shows an example of a flow diagram of process 102 for performing adaptive indoor positioning using a wireless indoor positioning signal transmitted from an AP. In process 102, blocks 140 and 152 are optional, as described for blocks 110 and 122 of FIG. 1A, respectively.

Block 140 of FIG. 1C may include descriptions of FIG. 1A for block 110.

Block 142 of FIG. 1C may include descriptions of FIG. 1A for block 114. In some cases, block 142 of FIG. 1C includes receiving a wireless signal from a transmitter, where the signal is not in response to a general unicast request signal, but is instead a signal sent periodically or sent for another reason by the AP. In some cases, block 142 of FIG. 1C includes decoding the received signal to generate a decoded signal.

Block 146 of FIG. 1C may include descriptions of FIG. 1A for block 116.

Block 148 of FIG. 1C may include descriptions of FIG. 1A for block 118. In some cases, block 148 of FIG. 1C includes determining, based on (e.g., data of) the decoded signal, that the received wireless signal has a predetermined power and predetermined frequency. In this case, block 148 may optionally include identifying the received wireless signal as a predetermined a wireless indoor positioning beacon, based on the decoded signal of the received wireless signal; and/or identifying the predetermined power and the predetermined frequency of the signal, based on the decoded signal of the received wireless signal.

Block 150 of FIG. 1C may include descriptions of FIG. 1A for block 120. In some cases, block 150 of FIG. 1C includes identifying a position of the mobile device, based on the determining (e.g., that the he received wireless signal has a predetermined power and predetermined frequency). In this case, block 150 may optionally include identifying, based on (e.g., predetermined data of) the decoded signal, a location of the transmitter that transmits the wireless signal, and determining a location of the mobile device relative to the transmitter, based on the location of the transmitter; and/or assuming a position of the transmitter based on a predefined threshold of the received signal RSSI or RTT. In this case, block 150 may optionally include determining, based on the position, an offset between a predicted RSSI value of the transmitter at that location, used in a heatmap and an observed actual RSSI value detected by the mobile device; and/or updating the heatmap based on the offset. In some cases, block 150 of FIG. 1B may include descriptions of block 150 for FIG. 1A.

Block 152 of FIG. 1C may include descriptions of FIG. 1A for block 122. After block 152, process 102 may return to block 140 (or 142 if block 140 is not performed).

FIG. 4 shows an example of a block diagram of a system or device in which aspects of embodiments of the invention may be practiced. FIG. 4 shows an example of mobile device 400 for calibrating physical sensors of the mobile device using a wireless indoor positioning signal transmitted from an AP. FIG. 4 shows mobile device 400 including physical sensor 411, receiver 414, and transmitter 440, and wireless indoor positioning processor 468.

The system may be a device 400, which may include a general purpose processor 461, image processor 466, positioning processor 468, graphics engine 467 and a memory 464. Device 400 may also include a number of device sensors coupled to one or more buses 477 or signal lines further coupled to the processor(s) 461, 466, and 468. Device 400 may be a: mobile device, wireless device, cell phone, personal digital assistant, mobile computer, tablet, personal computer, laptop computer, or any type of device that has processing capabilities.

In one embodiment device 400 is a mobile platform. Device 400 can include a physical (e.g., motion) sensors 411, such as accelerometers, gyroscopes, electronic compass, or other similar motion sensing elements. Any or all of these sensors may be calibrated when device 400 identifies that it is in a close range of an AP, such as noted herein (e.g., see FIGS. 1-3). Such calibrating may include identifying that device 400 is at a predetermined distance at which the mobile device is able to calibrate physical sensors of the mobile device within thresholds used for indoor positioning.

The device 400 may further include a user interface 450 that includes a means for displaying the images and/or objects, such as display 412. The user interface 450 may also include a keypad 452 or other input device through which the user can input information into the device 400. If desired, integrating a virtual keypad into the display 412 with a touch sensor may obviate the keypad 452. The user interface 450 may also include a microphone 454 and speaker 456, e.g., if the device 400 is a mobile platform such as a cellular telephone. Of course, device 400 may include other elements unrelated to the present disclosure, such as a satellite position system receiver (which may be used for outdoor positioning, and may in some embodiments assist in indoor positioning). It should be appreciated that device 400 may also include a display 412, a user interface (e.g., keyboard, touch-screen, or similar), a power device (e.g., a battery), as well as other components typically associated with electronic devices.

Device 400 may be a mobile or wireless device that may communicate using receiver 414 and transmitter 440 via one or more wireless communication links through a wireless network that are based on or otherwise support any suitable wireless communication technology, such as including Wi-Fi signals and data, as known in the art. Device 400 may communicate with AP1 (and vice versa) using various wireless technologies, such as using receiver 414 and transmitter 440.

For example, in some aspects device 400 and AP1 may associate with a network including a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, CDMA, TDMA, OFDM, OFDMA, WiMAX, and Wi-Fi. Similarly, a wireless device may support or otherwise use one or more of a variety of corresponding modulation or multiplexing schemes. According to embodiments, any or all of these signal types may be used to send signals 210 and 220. Device 400 and/or AP1 may wirelessly communicate with other mobile devices, cell phones, other wired and wireless computers, Internet web-sites, etc.

According to embodiments, user's experience (e.g., of device 400) can be greatly enhanced by providing wireless landmarks, which provide more accurate, efficient and reliable wireless indoor positioning and sensor calibration. Such landmarks can be provided using wireless access point (AP) as landmarks to aid precise wireless adaptive indoor positioning based on a wireless indoor positioning signal transmitted from a wireless access point (AP) to a mobile device to allow a mobile device to determine it's the position (e.g., as close to or at the AP's location). By providing such landmarks, embodiments can provide more accurate, convenient, automated, and efficient calibrating of physical sensors of the mobile device.

In some embodiments, providing wireless landmarks and calibrating may be provided by logic of device 400 (e.g., positioning processor 468), an AP, or the combination thereof. Such logic may include hardware circuitry, computer “modules”, software, BIOS, processing, processor circuitry, or any combination thereof. Such providing wireless landmarks and calibrating may include some or all of the processes of FIGS. 1-3.

In some cases, such logic of an AP (e.g., AP1) may include logic to perform wireless indoor positioning of a mobile device, as noted herein. This logic may include an indoor positioning signal generator configured to generate a signal to transmit to a mobile device, the signal to be received and decoded at the mobile device (e.g., this logic may perform some or all the “generates” of block 112). The signal generator may include a processor coupled to a memory, such as a memory including program instructions being executed by the processor to cause the processor to perform the function of the signal generator. This signal may have a predetermined transmission rate and a predetermined power that is known to be decodable by a plurality of typical types of mobile devices only when the mobile devices are within a predetermined distance from the transmitter. It may also include data identifying a location of the AP, that the signal has the predetermined transmission rate, and that the signal has the predetermined power. This logic may also include a wireless signal transmitter configured to transmit the signal to the mobile device (e.g., this logic may perform some or all of the “transmits” of block 112). This logic may include logic to perform other processes as noted herein for an AP, such as AP 1.

In some cases, such logic of device 400 may include logic to perform calibration of sensors of a mobile device for indoor positioning, as noted herein. This logic may include a wireless signal transmitter (e.g., transmitter 440) configured to transmit a general unicast request signal (e.g., this logic may perform some or all of blocks 110, 140 and block 310); a wireless signal receiver (e.g., receiver 414) configured to receive a wireless signal from an AP transmitter, in response to the general unicast request signal (e.g., a portion of processor 468 controlling or determining to send the response) (e.g., this logic may perform some or all of the “receives” processes of blocks 112 and 142); a decoder configured to decode the received signal into a decoded signal (e.g., a portion of processor 468) (e.g., this logic may perform some or all of the “decodes” processes of blocks 112 and 142; and some or all of blocks 116 and 146). This logic may include logic of a portion of positioning processor 468 to, based on data of the decoded signal, determine that the received wireless signal has a predetermined power and predetermined frequency (e.g., this logic may perform some or all of block 118); based on determining, identify a position of the mobile device (e.g., this logic may perform some or all of blocks 120 and 150); and based on the position, calibrate a physical sensor of the mobile device within thresholds used for indoor positioning (e.g., this logic may perform some or all of blocks 122 and 152). In some embodiments, this logic may include logic of a portion of positioning processor 468 to, based on predetermined data of the decoded signal, one of (1) identify the received wireless signal as a predetermined a wireless indoor positioning beacon (e.g., this logic may perform some or all of block 320), and (2) identify the predetermined power and the predetermined frequency of the signal (e.g., this logic may perform some or all of block 330). In addition, in some cases, this logic may include logic of a portion of positioning processor 468 to, based on predetermined data of the decoded signal, identify a location of the AP, and based on the location of the AP, determine a location of the mobile device relative to the transmitter (e.g., this logic may perform some or all of blocks 120 and 150). This logic may include logic to perform other processes as noted herein for device 400. In some cases, each of the logic identified above (e.g., each “this logic . . . ) may be embodied in a computer “module” to perform each of the processes noted above for each of those logic.

For an implementation involving firmware and/or software, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processing unit. Memory may be implemented within the processing unit or external to the processing unit. As used herein the term “memory” refers to any type of long term, short term, volatile, nonvolatile, or other memory and is not to be limited to any particular type of memory or number of memories, or type of media upon which memory is stored.

In some embodiments, the teachings herein may be incorporated into (e.g., implemented within or performed by) a variety of apparatuses (e.g., devices, including devices such as device 400 and an AP). Those of skill would further appreciate that the various illustrative logical blocks, modules, engines, circuits, and algorithm steps described in connection with the embodiments disclosed herein may be implemented as electronic hardware, computer software, or combinations of both. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various embodiments.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps (or processes) of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, flash memory, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions or modules described may be implemented in hardware (e.g., hardware 462), software (e.g., software 465), firmware (e.g., firmware 463), or any combination thereof (which may be represented in a computer module as positioning processor 468). If implemented in software as a computer program product, the functions or modules may be stored on or transmitted over as one or more instructions or code on a non-transitory computer-readable medium, such as having data (e.g., program instructions) therein which when accessed by a processor causes the processor, and/or hardware to perform some or all of the steps or processes described herein. In some cases, a computer program product having a computer-readable medium comprising code for perform the processes described herein (e.g., any or all of FIGS. 1-3). In some cases, an article of manufacture of a computer system comprising a non-transitory machine-readable medium having data therein which when accessed by a processor causes any or all of the modules described above for device 400 or an AP to perform the processes described herein (e.g., any or all of FIGS. 1-3).

Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

Thus, the methods, devices, systems and means described herein provide AP's with the ability to function as wireless landmarks for mobile devices 400, to aid precise wireless indoor positioning of such mobile devices; and provide more accurate sensor and/or sensor calibration of sensors of those mobile devices

The previous description of the disclosed embodiments is provided to enable any person skilled in the art to make or use the various embodiments. Various modifications to these embodiments will be readily apparent to those skilled in the art, and the generic principles defined herein may be applied to other embodiments without departing from the spirit or scope of the invention. For example, the close distance between device 400 and AP1 may be determined for non-mobile or fixed position devices, upon installation or initialization of such devices. Thus, the various embodiments are not intended to be limited to the embodiments shown herein but is to be accorded the widest scope consistent with the principles and novel features disclosed herein.

What is claimed is:

1. A machine implemented method to perform wireless indoor positioning of a mobile device, the machine implemented method comprising:
generating a signal to transmit to the mobile device, the signal to be received and decoded at the mobile device; and
transmitting the signal to the mobile device;
wherein the signal has a predetermined transmission rate and a predetermined power that is known to be decodable by the mobile device only when the mobile device is within a predetermined distance from a transmitter; and
wherein the signal includes data identifying a location of an access point (AP).

2. The machine implemented method of claim 1, wherein the signal comprises at least one of (1) a coded response from the AP to a general unicast request from the mobile device, (2) a periodic signal, (3) predetermined data identifying the received wireless signal as a predetermined wireless indoor positioning beacon, and (4) predetermined data identifying the predetermined power and a predetermined frequency of the signal.

3. The machine implemented method of claim 2, wherein the signal includes data identifying a physical location of the AP, and wherein the periodic signal from the AP includes data identifying a physical location of the AP.

4. The machine implemented method of claim 3, wherein the data identifying the physical location of the AP includes global coordinates of the AP or a relative location of the AP in local map coordinates.

5. The machine implemented method of claim 1, wherein the predetermined distance is a distance range within which the mobile device is able to estimate a turnaround calibration factor (TCF) for the mobile device and the AP based on a time of transmission of a signal from a general unicast request from the mobile device to the AP and a response received to that request from the AP.

6. The machine implemented method of claim 1, wherein the predetermined distance is a distance at which the mobile device is able to calibrate physical sensors of the mobile device within thresholds used for indoor positioning.

7. A method to calibrate sensors of a mobile device for indoor positioning:
receiving a wireless signal from a transmitter;
decoding the received wireless signal to generate a decoded signal;
determining, based on the decoded signal, that the received wireless signal has a predetermined power and a predetermined frequency;
identifying a position of the mobile device, based on the determining; and
calibrating, based on the position, a physical sensor of the mobile device within thresholds used for indoor positioning.

8. The method of claim 7, further comprising identifying the received wireless signal as a predetermined a wireless indoor positioning beacon, based on the decoded signal of the received wireless signal.

9. The method of claim 7, further comprising identifying the predetermined power and the predetermined frequency of the signal, based on the decoded signal of the received wireless signal.

10. The method of claim 7, further comprising:
identifying, based on the decoded signal, a location of the transmitter that transmits the wireless signal, and determining a location of the mobile device relative to the transmitter, based on the location of the transmitter.

11. The method of claim 7, further comprising:
assuming a position of the transmitter based on a predefined threshold of RSSI or RTT of the received wireless signal.

12. The method of claim 7, further comprising:
determining, based on the position, an offset between a predicted RSSI value of the transmitter at that location, used in a heatmap and an observed actual RSSI value detected by the mobile device; and
updating the heatmap based on the offset.

13. A device to perform wireless indoor positioning of a mobile device, comprising:
an indoor positioning signal generator configured to:
generate a signal to transmit to the mobile device, the signal to be received and decoded at the mobile device;
wherein the signal has a predetermined transmission rate and a predetermined power that is known to be decodable by the mobile device only when the mobile device is within a predetermined distance from a transmitter; and
wherein the signal includes data identifying a location of an access point (AP); and
a wireless signal transmitter configured to transmit the signal to the mobile device.

14. The device of claim 13, wherein the signal comprises at least one of (1) a coded response from the AP to a general unicast request from the mobile device, (2) a periodic signal, (3) predetermined data identifying the received wireless signal as a predetermined wireless indoor positioning beacon, and (4) predetermined data identifying the predetermined power and a predetermined frequency of the signal.

15. The device of claim 14, wherein the signal includes data identifying a physical location of the AP, and wherein the periodic signal from the AP includes data identifying a physical location of the AP.

16. The device of claim 15, wherein the data identifying the physical location of the AP includes global coordinates of the AP or a relative location of the AP in local map coordinates.

17. The device of claim 13, wherein the predetermined distance is a distance range within which the mobile device is able to estimate a turnaround calibration factor (TCF) for the mobile device and the AP based on a time of transmission of a signal from a general unicast request from the mobile device to the AP and a response received to that request from the AP.

18. The device of claim 13, wherein the predetermined distance is a distance at which the mobile device is able to calibrate physical sensors of the mobile device within thresholds used for indoor positioning.

19. A device to perform calibration of sensors of a mobile device for indoor positioning, comprising:
a wireless signal receiver configured to receive a wireless signal from a transmitter;
a decoder configured to decode the received wireless signal to generate a decoded signal; and
a positioning processor configured to:
determine, based on the decoded signal, that the received wireless signal has a predetermined power and a predetermined frequency;
identify a position of the mobile device, based on the determining; and
calibrate, based on the position, a physical sensor of the mobile device within thresholds used for indoor positioning.

20. The device of claim 19, the positioning processor further configured to:
identify the received wireless signal as a predetermined a wireless indoor positioning beacon, based on the decoded signal of the received wireless signal.

21. The device of claim 19, the positioning processor further configured to:
identify the predetermined power and the predetermined frequency of the signal, based on the decoded signal of the received wireless signal.

22. The device of claim 19, the positioning processor further configured to:
identify, based on the decoded signal, a location of the transmitter that transmits the wireless signal, and determining a location of the mobile device relative to the transmitter, based on the location of the transmitter.

23. The device of claim 19, further comprising:
assuming a position of the transmitter based on a predefined threshold of RSSI or RTT of the received wireless signal.

24. The device of claim 19, further comprising:
determining, based on the position, an offset between a predicted RSSI value of the transmitter at that location, used in a heatmap and an observed actual RSSI value detected by the mobile device; and
updating the heatmap based on the offset.

25. A computer program product comprising a non-transitory computer-readable medium to perform wireless indoor positioning of a mobile device, comprising code for:
generating a signal to transmit to the mobile device, the signal to be received and decoded at the mobile device; and
transmitting the signal to the mobile device;
wherein the signal has a predetermined transmission rate and a predetermined power that is known to be decodable by the mobile device only when the mobile device is within a predetermined distance from a transmitter; and
wherein the signal includes data identifying a location of an access point (AP).

26. The computer program product of claim 25, wherein the signal comprises at least one of (1) a coded response from the AP to a general unicast request from the mobile device, (2) a periodic signal, (3) predetermined data identifying the received wireless signal as a predetermined wireless indoor positioning beacon, and (4) predetermined data identifying the predetermined power and a predetermined frequency of the signal.

27. The computer program product of claim 25, wherein the predetermined distance is a distance range within which the mobile device is able to estimate a turnaround calibration factor (TCF) for the mobile device and the AP based on a time of transmission of a signal from a general unicast request from the mobile device to the AP and a response received to that request from the AP.

28. The computer program product of claim 25, wherein the predetermined distance is a distance at which the mobile device is able to calibrate physical sensors of the mobile device within thresholds used for indoor positioning.

29. A computer program product comprising a non-transitory computer-readable medium to calibrate sensors of a mobile device for indoor positioning, comprising code for:
receiving a wireless signal from a transmitter;
decoding the received wireless signal to generate a decoded signal;
determining, based on the decoded signal, that the received wireless signal has a predetermined power and a predetermined frequency;
identifying a position of the mobile device, based on the determining; and
calibrating, based on the position, a physical sensor of the mobile device within thresholds used for indoor positioning.

30. The computer program product of claim 29, further comprising code for:
identifying the received wireless signal as a predetermined a wireless indoor positioning beacon, based on the decoded signal of the received wireless signal.

31. The computer program product of claim 29, further comprising code for:
identifying the predetermined power and the predetermined frequency of the signal, based on the decoded signal of the received wireless signal.

32. The computer program product of claim 29, further comprising code for:
identifying, based on the decoded signal, a location of the transmitter that transmits the wireless signal, and determining a location of the mobile device relative to the transmitter, based on the location of the transmitter.

33. A computing device to perform wireless indoor positioning of a mobile device, comprising:
means for generating a signal to transmit to the mobile device, the signal to be received and decoded at the mobile device; and
means for transmitting the signal to the mobile device;
wherein the signal has a predetermined transmission rate and a predetermined power that is known to be decodable by the mobile device only when the mobile device is within a predetermined distance from a transmitter; and
wherein the signal includes data identifying a location of an access point (AP).

34. The computing device of claim 33, wherein the signal comprises at least one of (1) a coded response from the AP to a general unicast request from the mobile device, (2) a periodic signal, (3) predetermined data identifying the received wireless signal as a predetermined wireless indoor positioning beacon, and (4) predetermined data identifying the predetermined power and a predetermined frequency of the signal.

35. The computing device of claim 33, wherein the predetermined distance is a distance range within which the mobile device is able to estimate a turnaround calibration factor (TCF) for the mobile device and the AP based on a time of transmission of a signal from a general unicast request from the mobile device to the AP and a response received to that request from the AP.

36. The computing device of claim 33, wherein the predetermined distance is a distance at which the mobile device is able to calibrate physical sensors of the mobile device within thresholds used for indoor positioning.

37. A computing device to calibrate sensors of a mobile device for indoor positioning, comprising:
means for receiving a wireless signal from a transmitter;
means for decoding the received wireless signal to generate a decoded signal;
means for determining, based on the decoded signal, that the received wireless signal has a predetermined power and a predetermined frequency;
means for identifying a position of the mobile device, based on the determining; and
means for calibrating, based on the position, a physical sensor of the mobile device within thresholds used for indoor positioning.

38. The computing device of claim 37, further comprising:
means for identifying the received wireless signal as a predetermined a wireless indoor positioning beacon, based on the decoded signal of the received wireless signal.

39. The computing device of claim 37, further comprising:
means for identifying the predetermined power and the predetermined frequency of the signal, based on the decoded signal of the received wireless signal.

40. The computing device of claim 37, further comprising:
means for identifying, based on the decoded signal, a location of the transmitter that transmits the wireless signal, and determining a location of the mobile device relative to the transmitter, based on the location of the transmitter.
